(19) United States
(12) Patent Application Publication
(10) Pub. No.: US 2025/0201893 A1
(43) Pub. Date: Jun. 19, 2025

(54) Unwinding Device for Manufacturing Secondary Battery and Secondary Battery Manufacturing System Including the Same

(71) Applicant: LG Energy Solution, Ltd., Seoul (KR)

(72) Inventor: Yeong-Tae Gwon, Daejeon (KR)

(73) Assignee: LG Energy Solution, Ltd., Seoul (KR)

(21) Appl. No.: 18/836,146

(22) PCT Filed: Nov. 13, 2023
(86) PCT No.: PCT/KR2023/018197

§ 371 Date: Mar. 5, 2025

(30) Foreign Application Priority Data
Dec. 23, 2022 (KR) 10-2022-0182923

(51) Int. Cl. H01M 10/04; G01B 11/02; G01B 11/06

(52) U.S. Cl. CPC H01M 10/0404; G01B 11/026; G01B 11/0691

(57) ABSTRACT

An unwinding device for manufacturing a secondary battery includes an unwinder, a transfer unit, and a correction unit having a rotation shaft. The unwinder is configured for unwinding a coating substrate wound in a roll shape by rotating it around the rotation shaft. The transfer unit includes a first transfer roll disposed closest to the unwinder. The correction unit is configured for correcting (i.e., moving) the position of the rotation shaft with respect to the first transfer roll.

### CROSS-REFERENCE TO RELATED APPLICATIONS

The present application is a national phase entry under 35 U.S.C. § 371 of International Application No. PCT/KR2023/018197 filed Nov. 13, 2023, which claims priority to Korean Patent Application No. 10-2022-0182923 filed Dec. 23, 2022, all the disclosures of which are incorporated herein by reference.

### TECHNICAL FIELD

The present disclosure relates to an unwinding device for manufacturing a secondary battery and a secondary battery manufacturing system including the same, and more specifically, to an unwinding device for manufacturing a secondary battery capable of minimizing deformation of a coating substrate during the unwinding process in a roll-to-roll process for manufacturing a secondary battery, and a secondary battery manufacturing system including the same.

### BACKGROUND ART

In general, a secondary battery refers to a battery that can be repeatedly charged and discharged, such as a lithium-ion battery, a lithium polymer battery, a nickel cadmium battery, a nickel hydrogen battery, a nickel zinc battery, and the like. Such a secondary battery may be manufactured by accommodating an electrode assembly including a positive electrode and a negative electrode stacked on each other with an insulating separator interposed therebetween, and an electrolyte material in various types of cases, and then sealing the corresponding case.

In addition, the electrodes and separators of a secondary battery may be manufactured using a roll-to-roll process. That is, while unwinding and transferring a strip-shaped substrate wound in a roll shape, a coating process, a drying process, a roll pressing process, a slitting process, and a notching process may be continuously performed on the corresponding substrate in an in-line manner. In this roll-to-roll method, winding and unwinding processes may be performed for each corresponding process.

In particular, a process of unwinding the electrode reel on which the processed substrate is wound after the slitting process is required to perform the notching process. In this process, the winding amount of the electrode (or substrate, semi-processed coating substrate, hereinafter collectively referred to as coating substrate) wound on the electrode reel inevitably decreases as time goes by, and the movement angle of the coating substrate (or the approach angle of the substrate facing toward the transfer roller) moving from the electrode reel to the transfer roller is bound to change. If the movement angle of the unwound coating substrate is changed in this way, the degree of bending of the coating substrate engaged with the transfer unit is changed, which may result in a problem that causes deformation of the coating substrate. That is, based on any one transfer roller, the degree of bending formed by the discharged substrate and the substrate facing toward the transfer roller from the electrode reel may be increased. In particular, this phenomenon tends to intensify on the first transfer roller. This bending phenomenon increases the possibility of creating wrinkles on the electrode uncoated portion, and the wrinkles may prevent the tab from being positioned uniformly on the electrode uncoated portion, thereby causing folding, damage, and defects of the tab in the subsequent notching process.

### DISCLOSURE

### Technical Problem

The present disclosure is designed to solve the problems of the related art, and therefore the present disclosure is directed to providing an unwinding device for manufacturing a secondary battery capable of minimizing deformation of the coating substrate by reducing the change in the movement angle of the coating substrate moving from the unwinder to the first transfer roll, and a secondary battery manufacturing system including the same.

Technical problems to be solved by the present disclosure are not limited to the above-described problems, and other problems not mentioned herein may be clearly understood by those skilled in the art from the following description of the present disclosure.

### Technical Solution

An unwinding device for manufacturing a secondary battery according to the present disclosure for solving the above-described problem may include an unwinder unwinding a coating substrate wound in a roll shape by rotating it around a rotation shaft; a transfer unit including a first transfer roll disposed closest to the unwinder; and a correction unit provided on the rotation shaft and correcting the position of the rotation shaft with respect to the first transfer roll.

The correction unit may move the position of the rotation shaft in the first direction so that the entry angle of the coating substrate formed from the first transfer roll to the outer peripheral surface of the coating substrate wound on the unwinder is formed within a preset range.

The unwinding device for manufacturing a secondary battery may further include a sensor unit sensing the distance to the outer peripheral surface of the electrode reel, which is the wound coating substrate.

The sensor unit may sense the thickness of the wound coating substrate by sensing the distance of the outer peripheral surface of the electrode reel that changes while the coating substrate is being unwound.

The correction unit may further include a lifting frame; and an up/down driving unit connected to the lifting frame to drive the rotation shaft up/down in the first direction.

The lifting frame may be provided with a hub bearing to which the rotation shaft is rotatably coupled.

The unwinder may further include a support frame, and a long hole may be formed in the support frame so that the rotation shaft is moved up/down.

The sensor unit may be provided in the support frame.

The sensor unit may measure the time of flight of the light reflected by being irradiated to the outer peripheral surface of the electrode reel.

The up/down driving unit may be a pneumatic or hydraulic cylinder.

According to another aspect, the unwinding device for manufacturing a secondary battery may further include a transfer roll correction unit that corrects the position of the transfer unit in the second direction.

Here, the transfer roll correction unit may include a correction rod rotatably connected to the first transfer roll; and a rod driving unit that drives the correction rod forward or backward in the second direction.

In addition, according to the present disclosure, a secondary battery manufacturing system including an unwinding device for manufacturing a secondary battery described above may be provided.

### Advantageous Effects

According to one aspect of the present disclosure, the rotation shaft of the unwinder with respect to the transfer unit may be corrected even if the winding amount of the coating substrate wound on the unwinder is reduced, thereby minimizing deformation of the coating substrate by reducing the change in the movement angle of the coating substrate moving from the unwinder to the first transfer roll.

In addition, according to one aspect of the present disclosure, while the wound coating substrate is being unwound, the sensor unit may move the rotation shaft in response to the winding amount of the coating substrate, thereby minimizing the degree of bending formed by the discharged substrate and the substrate facing toward the transfer roller from the electrode reel based on the first transfer roll, and accordingly, folding, damage, and defects of the tab during the notching process may be reduced.

The effects of the present disclosure are not limited to the above-described effects, and other effects not mentioned herein may be clearly understood by those skilled in the art from this specification and the accompanying drawings.

### DESCRIPTION OF DRAWINGS

The accompanying drawings illustrate a preferred aspect of the present disclosure and together with the foregoing disclosure, serve to provide further understanding of the technical features of the present disclosure, and thus the present disclosure is not construed as being limited to the drawing.

FIG. 1 is a view schematically showing a side portion of an unwinding device for manufacturing a secondary battery according to an aspect of the present disclosure.

FIG. 2 is a view schematically showing a front portion of an unwinding device for manufacturing a secondary battery according to an aspect of the present disclosure.

FIG. 3 is a partial enlarged view of FIG. 2.

FIG. 4 is a view showing an unwinding device for manufacturing a secondary battery according to an aspect of the present disclosure.

FIG. 5 is a view showing the correction operation of an unwinding device for manufacturing a secondary battery according to an aspect of the present disclosure.

FIG. 6 is a view showing the state of an electrode that has been unwound and moved by an existing unwinder.

FIG. 7 is a view showing the state of an electrode that has been unwound and moved according to the present disclosure.

FIG. 8 is a view schematically showing a first transfer roll and a transfer roll correction unit in an unwinding device for manufacturing a secondary battery according to another aspect of the present disclosure.

FIG. 9 is a view showing the correction operation of a transfer roll correction unit in an unwinding device for manufacturing a secondary battery according to another aspect of the present disclosure.

### DETAILED DESCRIPTION

Hereinafter, preferred aspects of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

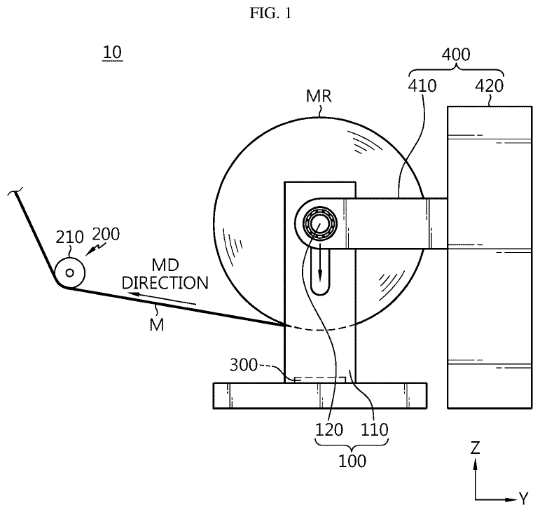

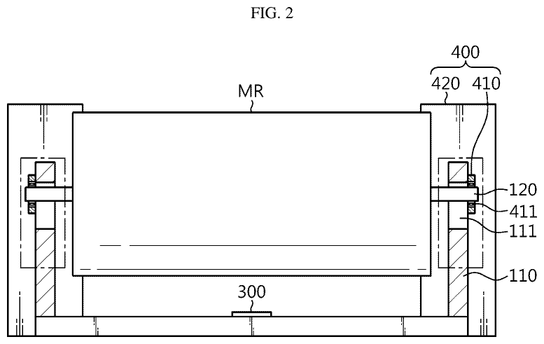

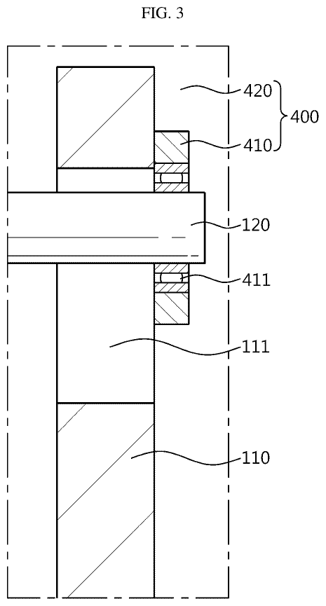

FIG. 1 is a view schematically showing a side portion of an unwinding device for manufacturing a secondary battery according to an aspect of the present disclosure, FIG. 2 is a view schematically showing a front portion of an unwinding device for manufacturing a secondary battery according to an aspect of the present disclosure, and FIG. 3 is a partial enlarged view of FIG. 2.

Referring to FIGS. 1 to 3, an unwinding device 10 for manufacturing a secondary battery according to an aspect of the present disclosure may include an unwinder 100, a transfer unit 200 including a first transfer roll 210, a sensor unit 300, and a correction unit 400.

The unwinder 100 may be configured to unwind the coating substrate M. The coating substrate M may be a metal foil corresponding to a current collector of an electrode, or a porous polymer substrate corresponding to an insulator of a separator. Alternatively, the coating substrate M may be an electrode or an electrode sheet where an electrode active material is applied and dried on the above-mentioned substrate. In this aspect, it may be an electrode sheet where slitting has been completed for a notching process.

The unwinder 100 may unwind the coating substrate M wound in a roll shape by rotating it around a rotation shaft 120. Specifically, the unwinder 100 may include a support frame 110 and a rotation shaft 120 rotatably coupled to the support frame 110.

The support frame 110 may be disposed in a pair spaced apart by a predetermined width formed by the wound coating substrate M. The rotation shaft 120 may be rotatably coupled to the pair of support frames 110 therebetween. A long hole 111 may be formed in the support frame 110 so that the rotation shaft 120 is moved up/down. Through the long hole 111, movement of the rotation shaft 120 in the first direction may be possible. For example, the first direction may be an upward/downward direction or a vertical direction. On the other hand, movement of the rotation shaft 120 in other directions (e.g., Y-axis direction, etc.) may be restricted by the long hole 111.

The sensor unit 300 may be disposed on this support frame 110. The sensor unit 300 may be disposed at the center of the pair of support frames 110 spaced apart by a predetermined width.

The rotation shaft 120 may be disposed on the long hole 111, and a coating substrate M produced by winding a strip-shaped secondary battery substrate may be wound on the rotation shaft 120. Here, the portion where the coating substrate M is wound is referred to as an electrode reel MR, and the electrode reel MR may be coupled to the rotation shaft 120. The coating substrate M unwound from the electrode reel MR may be transferred in the MD (Machine Direction) direction by the first transfer roll 210. For example, the electrode reel MR on which the coating substrate M where the slitting process has been performed is wound may be unwound through the unwinder 100 and transferred in the MD direction to be put in a notching process or notching equipment.

The transfer unit 200 may be a part that transfers the unwound coating substrate M. To this end, the transfer unit 200 may include a plurality of transfer rolls. And, since the transfer unit 200 includes a plurality of transfer rolls, and the plurality of transfer rolls are sequentially arranged in a row, the unwound coating substrate M may be continuously unwound and then supplied to a subsequent equipment. In the drawings, only the first transfer roll 210 is shown, and the other transfer rolls are omitted.

The transfer unit 200 may include a first transfer roll 210 disposed closest to the unwinder 100. The first transfer roll 210 may be the first to come into contact with the coating substrate M unwound and released from the electrode reel MR. Depending on the position of the first transfer roll 210 relative to the rotation shaft 120 of the unwinder 100, the movement path where the unwound coating sheet moves from the electrode reel MR may vary, and the entry angle of the coating substrate M to the first transfer roll 210 may be changed.

The sensor unit 300 may be a part that senses a distance to the outer peripheral surface of the coating substrate M. The sensor unit 300 may sense the thickness of the wound coating substrate M by sensing the distance of the outer peripheral surface of the coating substrate M that changes while the coating substrate M is being unwound. That is, the sensor unit 300 may sense the thickness of the wound coating substrate M by measuring a distance to the outermost peripheral surface of the wound coating substrate M, that is, the electrode reel MR.

The correction unit 400 is provided on the rotation shaft 120 and may be a part that corrects the position of the rotation shaft 120 with respect to the first transfer roll 210. The correction unit 400 may move the position of the rotation shaft 120 in the first direction (Z-axis direction) so that the entry angle of the coating substrate M formed from the first transfer roll 210 to the outer peripheral surface of the coating substrate M wound on the unwinder 100 is formed within a preset range.

That is, during the unwinding process, the thickness of the electrode reel MR is reduced, and accordingly, the movement path along which the unwound coating sheet moves from the electrode reel MR may vary, and the entry angle of the coating substrate M with respect to the first transfer roll 210 may be changed. The correction unit 400 may move the engaged rotation shaft 120 of the electrode reel MR downward in the first direction, so that the entry angle of the coating substrate M may be formed within a preset range.

Through this configuration, deformation of the coating substrate M may be minimized by reducing the change in the movement angle of the coating substrate M moving from the unwinder 100 to the first transfer roll 210.

Hereinafter, the sensor unit 300 and the correction unit 400 will be described in detail.

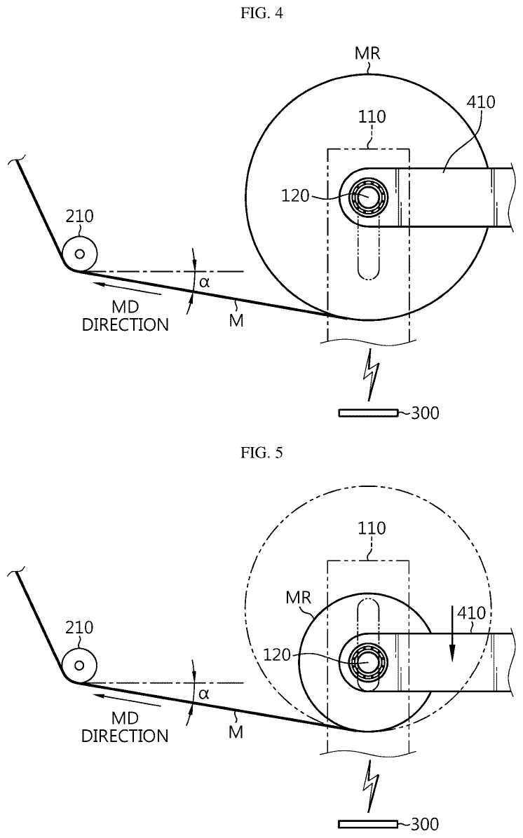

FIG. 4 is a view showing an unwinding device for manufacturing a secondary battery according to an aspect of the present disclosure.

It is necessary to sense whether the winding amount of the coating substrate M wound on the unwinder 100 is reduced or whether the thickness of the electrode reel MR is reduced. Accordingly, a sensor unit 300 may be provided in the unwinding device 10 for manufacturing a secondary battery in this aspect.

Referring to FIG. 3 and FIGS. 1 and 2 again, the sensor unit 300 may be provided on the support frame 110. This sensor unit 300 may be a distance sensing sensor. The sensor unit 300 may measure the time of flight (TOF) of light reflected by being irradiated to the outer peripheral surface of the wound coating substrate M, that is, the electrode reel MR. While the electrode reel MR is being unwound in the unwinder 100, it may be configured to sense the distance from a predetermined position to the outer peripheral surface of the electrode reel MR.

On the other hand, the movement angle of the coating substrate M moved between the electrode reel MR and the transfer unit 200, particularly the first transfer roll 210, changes as the radius of the electrode reel MR decreases over time. Accordingly, it is necessary to correct the rotation shaft 120 of the unwinder 100 with respect to the transfer unit 200.

The correction unit 400 may be configured to correct the position of the rotation shaft 120 that supports and rotates the electrode reel MR according to the distance sensed by the sensor unit 300.

Specifically, the correction unit 400 may include a lifting frame 410; and an up/down driving unit 420 connected to the lifting frame 410 to drive the rotation shaft 120 up/down in the first direction.

The lifting frame 410 may be configured to support the rotation shaft 120 of the unwinder 100. The lifting frame 410 may be provided with a hub bearing to which the rotation shaft 120 is rotatably coupled. Accordingly, the lifting frame 410 may rotatably support the rotation shaft 120.

This lifting frame 410 may be moved up/down in the first direction (Z-axis direction).

The up/down driving unit 420 may be a part that drives the lifting frame 410 up/down in the first direction. The up/down driving unit 420 may be configured to correct the position of the rotation shaft 120 supporting the electrode reel MR by changing the position of the lifting frame 410 in response to the amount of change in distance sensed by the sensor unit 300. The up/down driving unit 420 in this aspect may be a pneumatic or hydraulic cylinder.

According to this aspect, the rotation shaft 120 of the unwinder 100 with respect to the transfer unit 200 may be corrected even if the winding amount of the coating substrate M of the electrode reel MR on the unwinder 100 is reduced, thereby minimizing deformation of the coating substrate M by reducing the change in the movement angle of the coating substrate M moving from the unwinder 100 to the first transfer roll 210.

In addition, while the wound coating substrate M is being unwound, the sensor unit 300 may move the rotation shaft 120 in response to the winding amount of the coating substrate M, thereby minimizing the degree of bending formed by the discharged substrate and the coating substrate M facing toward the first transfer roll 210 from the electrode reel MR based on the first transfer roll 210, and accordingly, folding, damage, and defects of the tab during the notching process may be reduced.

Hereinafter, the correction operation of the correction unit 400 will be described in more detail.

FIG. 5 is a view showing the correction operation of an unwinding device for manufacturing a secondary battery according to an aspect of the present disclosure.

Referring to FIG. 4 again, the electrode reel MR is engaged with the rotation shaft 120, and the unwinder 100 may unwind the electrode reel MR by rotating it around the rotation shaft 120. When the electrode reel MR is rotated around the rotation shaft 120 and unwound, the unwound coating substrate M may be transferred in the MD (Machine Direction) direction by the first transfer roll 210.

While the electrode reel MR is being unwound, the sensor unit 300 may sense the distance from a predetermined position to the outer peripheral surface of the electrode reel MR. For example, the sensor unit 300 may be disposed side by side with the rotation shaft 120 of the unwinder 100 in the Z-axis direction to sense the distance to the outer peripheral surface of the electrode reel MR.

Referring to FIG. 5, as time goes by, the radius of the electrode reel MR decreases, and the distance sensed by the sensor unit 300 increases. The time of flight (TOF) of the light reflected by being irradiated to the outer peripheral surface of the wound coating substrate is measured.

The correction unit 400 may correct the position of the rotation shaft 120 that supports and rotates the electrode reel MR according to the distance sensed by the sensor unit 300. That is, the up/down driving unit 420 of the correction unit 400 changes the position of the lifting frame 410 in response to the amount of change in distance sensed by the sensor unit 300. A slight movement of the lifting frame 410 downward by driving it in the first direction may correct the position of the rotation shaft 120. For example, the correction unit 400 may move the rotation shaft 120 in the −Z-axis direction so that the outer peripheral surface of the electrode reel MR is located within a preset range based on the Z direction in the drawing.

According to this aspect, the rotation shaft 120 of the unwinder 100 with respect to the transfer unit 200 may be corrected even if the winding amount of the coating substrate M of the electrode reel MR on the unwinder 100 is reduced, thereby minimizing deformation of the coating substrate M by reducing the change in the movement angle of the coating substrate M moving from the unwinder 100 to the first transfer roll 210.

In addition, while the wound coating substrate M is being unwound, the sensor unit 300 may move the rotation shaft 120 in response to the winding amount of the coating substrate M, thereby minimizing the degree of bending formed by the discharged substrate and the coating substrate M facing toward the first transfer roll 210 from the electrode reel MR based on the first transfer roll 210, and accordingly, folding, damage, and defects of the tab during the notching process may be reduced.

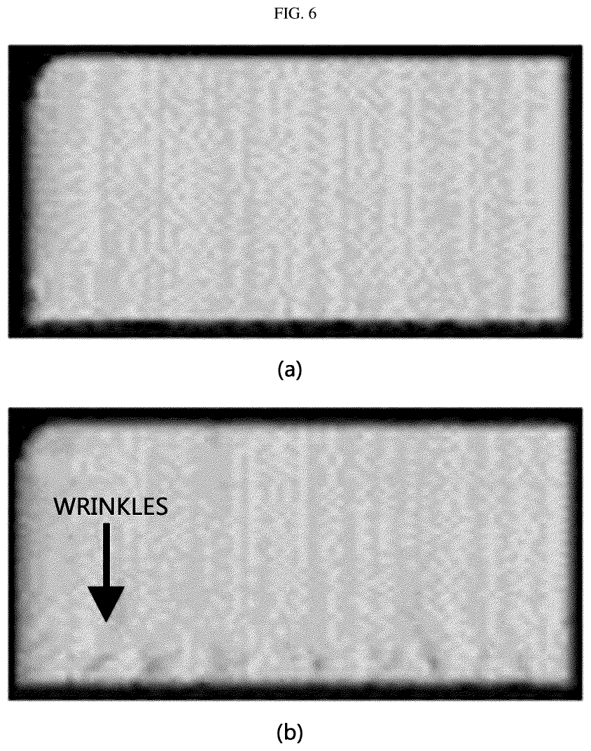

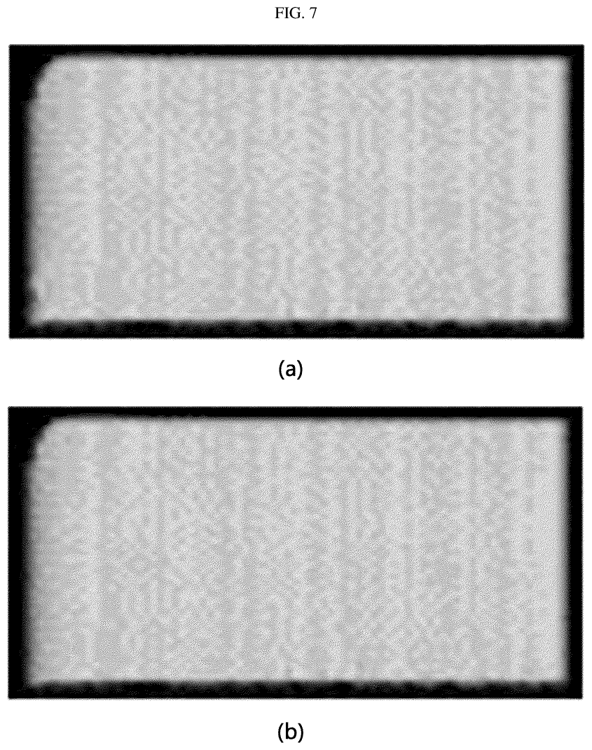

FIG. 6 is a view showing the state of an electrode that has been unwound and moved by an existing unwinder, and FIG. 7 is a view showing the state of an electrode that has been unwound and moved according to the present disclosure.

As shown in (a) of FIG. 6, in the case of the electrode unwound and transferred from the electrode reel MR in which a strip-shaped electrode is wound into a roll shape at the beginning of the roll-to-roll process, the degree of bending in the first transfer roll 210 is not significant, thereby creating no wrinkles on the electrode uncoated portion.

On the other hand, as shown in (b) of FIG. 6, in the case of the electrode unwound and transferred from the electrode reel MR whose radius is reduced as the roll-to-roll process proceeds, the degree of bending in the transfer roller increases, so that bending creates wrinkles on the electrode uncoated portion. As a result, it can be confirmed that the tab provided in the electrode uncoated portion is folded or damaged, which may cause a deterioration in the yield and quality of the electrode.

In the case of the electrode unwound and transferred from the electrode roll at the beginning of the roll-to-roll process, the degree of bending in the first transfer roll 210 is not significant, thereby creating no wrinkles on the electrode uncoated portion as shown in FIG. 7 (a).

In addition, even when the radius of the electrode roll decreases as the roll-to-roll process proceeds, the correction unit 400 corrects the position of the electrode reel MR by moving the height of the rotation shaft 120 in the −Z-axis direction in consideration of the reduced thickness of the electrode reel MR, and as a result of, the degree of bending of the coating substrate M in the first transfer roll 210 is maintained as initially, thereby creating no wrinkles on the electrode uncoated portion as shown in FIG. 7 (b). Accordingly, folding, damage, and defects of the tab during the notching process may be reduced.

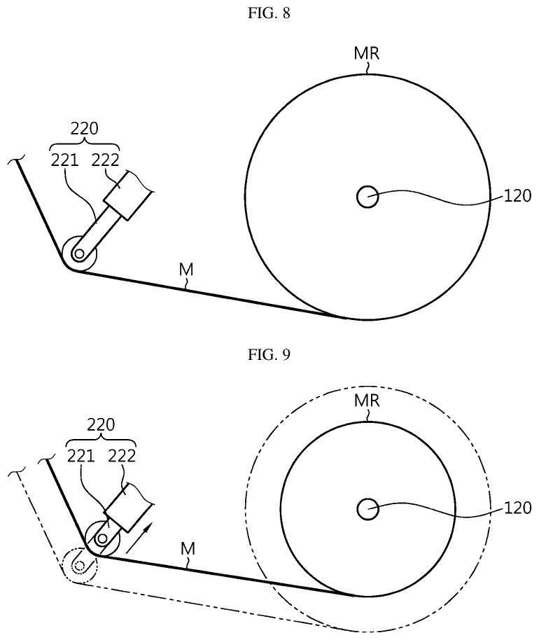

Next, other aspects of the unwinding device for manufacturing a secondary battery of the present disclosure will be briefly described with reference to FIGS. 8 and 9.

FIG. 8 is a view schematically showing a first transfer roll and a transfer roll correction unit in an unwinding device for manufacturing a secondary battery according to another aspect of the present disclosure, and FIG. 9 is a view showing the correction operation of a transfer roll correction unit in an unwinding device for manufacturing a secondary battery according to another aspect of the present disclosure.

The same reference numerals as in the previous drawings indicate the same members, and redundant descriptions of the same members will be omitted and the differences from the above-described aspect will be mainly described.

Referring to FIGS. 8 and 9, in the unwinding device for manufacturing a secondary battery according to another aspect of the present disclosure, a transfer roll correction unit 220 may be provided in the transfer unit 200.

The transfer roll correction unit 220 may correct the position of the transfer unit 200 in the second direction. Specifically, the transfer roll correction unit 220 may include a correction rod 221 rotatably connected to the first transfer roll 210; and a rod driving unit 222 that drives the correction rod 221 forward or backward in the second direction.

The correction rod 221 may position the first transfer roll 210 in the second direction depending on the degree of expansion and contraction. And, the correction rod 221 may be driven by the rod driving unit 222. In the drawing, the correction rod 221 is contracted, thereby allowing the first transfer roll 210 to move to the upper right side. At this time, there is no movement of the rotation shaft 120.

In this way, by correcting the position of the first transfer roll 210, deformation of the coating substrate M may be minimized by reducing the change in the movement angle of the coating substrate M moving from the unwinder 100 to the first transfer roll 210.

For example, the correction unit 400 moves the rotation shaft 120 where the electrode reel MR is engaged in the first direction, and when excessive displacement of the rotation shaft 120 needs to be corrected, a burden is imposed on the correction unit 400. In addition, since the electrode reel MR itself may weigh considerably, the correction work with the correction unit 400 may be limited.

On the other hand, when the position of the first transfer roll 210 according to this aspect may be adjusted in the second direction, deformation of the coating substrate M may be minimized by reducing the change in the movement angle of the coating substrate M moving to the first transfer roll 210 without moving the position of the rotation shaft 120. Alternatively, although not shown in the drawing, a case where a smaller displacement movement of the correction unit 400 is combined with the operation of the transfer roll correction unit 220 may also be considered. Therefore, it is possible to minimize the degree of bending formed by the coating substrate M facing toward the first transfer roll 210 from the electrode reel MR, and ultimately, folding, damage, and defects of the tab during the notching process may be reduced.

Meanwhile, a secondary battery manufacturing system according to an aspect of the present disclosure includes the unwinding device 10 for manufacturing a secondary battery described above.

According to an aspect, the secondary battery manufacturing system may further include one or two or more devices among a coating material manufacturing device, a coating device, a drying device, a rolling device, a slitting device, and a notching device.

The coating material manufacturing device may be configured to mix and prepare a coating material for forming an electrode active layer in which an actual electrochemical reaction occurs in the electrode.

For example, when the electrode to be manufactured is a wet electrode, the coating material manufacturing device may be configured to prepare an electrode mixture in a slurry state having fluidity as a coating material by mixing an electrode active material that is an integral element of the electrode, a conductive material and a filler that are other additives, a binder for binding between powders and adhesion to a current collector, a solvent for imparting viscosity and dispersing powders, and the like.

On the other hand, when the electrode to be manufactured is a dry electrode, the coating material mixing device may be configured to prepare an electrode mixture in a powder state as a coating material by mixing a conductive material, a filler, a binder, and the like together with an electrode active material. In this case, the secondary battery manufacturing system may not include the drying device.

The coating device may be configured to apply the coating material to an electrode foil corresponding to a current collector. When the electrode to be manufactured is a dry electrode, the coating device may include a calendering roll for calendering a coating material in a powder state to create a free-standing type electrode film, and a laminating roll for pressing and attaching the electrode film to the surface of the electrode foil.

The drying device is applied when the electrode to be manufactured is a wet electrode, and it may be configured to dry the coating material applied to the electrode foil. When the electrode to be manufactured is a dry electrode, the drying device may be omitted.

The rolling device may be configured to control the thickness of the coating layer by performing a roll pressing process on the electrode where the coating layer is formed.

The slitting device may be configured to slit the coated electrode.

The notching device may be configured to form a notch in the uncoated portion of the slit electrode.

As described above, according to the present disclosure, the distance sensor senses the distance from a predetermined position to the outer peripheral surface of the wound substrate while the wound substrate is being unwound, and the correction unit 400 corrects the position of the rotation shaft 120 according to the distance sensed by the distance sensor, thereby enabling to provide an unwinding device 10 for manufacturing a secondary battery that may maintain the movement angle of a portion of the substrate that is unwound and moved within a certain range even when the radius decreases as the substrate wound in a roll shape is unwound in the roll-to-roll process for manufacturing a secondary battery, and may prevent deformation of the substrate due to a change in the movement angle, and a secondary battery manufacturing system including the same.

Meanwhile, the terms indicating directions as used herein such as upper, lower, left, right, front, and rear are used for convenience of description only, and it is obvious to those skilled in the art that the term may change depending on the position of the stated element or an observer.

The present disclosure has been hereinabove described with regard to a limited number of aspects and drawings, but the present disclosure is not limited thereto and it is obvious to those skilled in the art that a variety of modifications and changes may be made thereto within the technical aspects of the present disclosure and the equivalent scope of the appended claims.

The description of the present disclosure and the accompanying drawings for illustrating aspects thereof may be shown in a somewhat exaggerated form to emphasize or highlight the technical content of the present disclosure, but it should be interpreted as obvious that various types of modified application examples may be possible at the level of a person of ordinary skill in the art in view of the foregoing description and the matters shown in the drawings.

1. An unwinding device for manufacturing a secondary battery using a coating substrate wound on an electrode reel, the unwinding device comprising:
a correction unit having a rotation shaft;
an unwinder configured to unwind the coating substrate wound on the electrode reel in a roll shape by rotating the electrode reel around the rotation shaft; and
a transfer unit comprising a first transfer roll spaced from the unwinder,
wherein the correction unit is configured to adjust the position of the rotation shaft with respect to the first transfer roll.

2. The unwinding device for manufacturing a secondary battery according to claim 1,
wherein the correction unit is configured to move the rotation shaft along a first direction so that an entry angle of the coating substrate extending from the first transfer roll to an outer peripheral surface of the electrode reel is within a preset range.

3. The unwinding device for manufacturing a secondary battery according to claim 2, further comprising
a sensor unit configured to sense a distance between the outer peripheral surface of the electrode reel defined by the wound coating substrate and the sensor unit.

4. The unwinding device for manufacturing a secondary battery according to claim 3,
wherein the sensor unit is configured to sense the thickness of the wound coating substrate by sensing changes in the distance while the coating substrate is being unwound.

5. The unwinding device for manufacturing a secondary battery according to claim 3,
wherein the correction unit further comprises:
a lifting frame; and
an up/down driving unit connected to the lifting frame and configured to move the rotation shaft up and down along the first direction.

6. The unwinding device for manufacturing a secondary battery according to claim 5,
wherein the lifting frame has a hub bearing to which the rotation shaft is rotatably coupled.

7. The unwinding device for manufacturing a secondary battery according to claim 3,
wherein the unwinder further comprises a support frame having an elongated hole, and wherein the rotation shaft is configured to moved up and down along the elongated hole.

8. The unwinding device for manufacturing a secondary battery according to claim 7,
wherein the sensor unit is disposed on the support frame.

9. The unwinding device for manufacturing a secondary battery according to claim 3,
wherein the sensor unit is configured to measure a time of flight of light reflected by the outer peripheral surface of the electrode reel.

10. The unwinding device for manufacturing a secondary battery according to claim 5,
wherein the up/down driving unit is a pneumatic or hydraulic cylinder.

11. The unwinding device for manufacturing a secondary battery according to claim 1, further comprising
a transfer roll correction unit configured to move the transfer unit along a second direction.

12. The unwinding device for manufacturing a secondary battery according to claim 11,
wherein the transfer roll correction unit comprises:
a correction rod rotatably connected to the first transfer roll; and
a rod driving unit configured to move the correction rod forward or backward along the second direction.

13. A secondary battery manufacturing system comprising an unwinding device for manufacturing a secondary battery according to claim 1.
